(19) United States
(12) Patent Application Publication
(10) Pub. No.: US 2007/0235009 A1
(43) Pub. Date: Oct. 11, 2007

(54) Control apparatus for direct injection type spark ignition internal combustion engine

(75) Inventors: Minoru Nakashima, Hyogo (JP); Akira Huruta, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 11/606,922

(22) Filed: Dec. 1, 2006

(30) Foreign Application Priority Data
Apr. 10, 2006 (JP) 2006-107578

(51) Int. Cl. F02M 59/36

(52) U.S. Cl. 123/458; 123/501

(57) ABSTRACT

A control apparatus for a direct injection type spark ignition internal combustion engine can prevent the deterioration of combustion resulting from fuel adhesion according to the deterioration of performance of an injector. The apparatus includes a variety of kinds of sensors that detect an operating condition of an internal combustion engine, a target fuel injection amount calculation section that calculates a target amount of fuel to be injected based on the engine operating state, a fuel injection pressure control section that controls the injection pressure of fuel to be injected into a combustion chamber, a fuel injection timing control section, and a combustion state detection section that detects the deterioration of combustion of the internal combustion engine. The fuel injection timing control section includes a fuel pressure correction section that corrects the fuel injection pressure. The fuel pressure correction section corrects the fuel injection pressure when the deterioration of combustion is detected by the combustion state detection section.

### BACKGROUND OF THE INVENTION

1. Field of the Invention

The present invention relates to a control apparatus for a direct injection type spark ignition internal combustion engine installed on a vehicle such as for example a motor vehicle, and in particular, to a new technique for appropriately changing fuel injection pressure in accordance with the deterioration of combustion of the internal combustion engine.

2. Description of the Related Art

In the past, as this kind of control apparatus for a direct injection type spark ignition internal combustion engine, there has been known one which is constructed such that an excellent mixture is obtained even in a high rotational speed range while sufficient charging efficiency can be obtained in a low rotational speed range, and at the same time, appropriate fuel injection timing can be set so as not to deteriorate fuel mileage particularly in case where switching can be made between an early injection mode and a late injection mode (see, for example, a first patent document: Japanese patent application laid-open No. H9-79081).

Although in the above-mentioned conventional apparatus, appropriate fuel injection timing is set so as to prevent fuel adhesion to a piston that is moving in a combustion chamber, the fuel injection timing is set based on the design value of a fuel injector, so even manufacturing errors are included within the range of such a setting.

Accordingly, there is a possibility that the amount that the amount of injected fuel adhering to the top surface of the piston might increase if there occurs an extreme offset in excess of the above-mentioned product errors in the shape of fuel spray in accordance with the deterioration of performance of the injector, for example.

In the conventional control apparatus for a direct injection type spark ignition internal combustion engine, there has been a problem that when an extreme offset occurs in the shape of fuel spray due to the deterioration of performance of the injector, etc., the amount of fuel adhesion to the piston top surface might increase, whereby a fuel lean state ca be caused, thus leading to rotational fluctuations and misfiring.

### SUMMARY OF THE INVENTION

Accordingly, the present invention is intended to obviate the problem as referred to above, and has for its object to obtain a control apparatus for a direct injection type spark ignition internal combustion engine which can suppress the deterioration of combustion by correcting fuel injection pressure upon detection of such combustion deterioration.

Bearing the above object in mind, according to the present invention, there is provided a control apparatus for a direct injection type spark ignition internal combustion engine in which fuel is directly injected to a combustion chamber of the internal combustion engine. The apparatus includes: a variety of kinds of sensors that detect an operating condition of the internal combustion engine; a target fuel injection amount calculation section that calculates a target value for an amount of fuel to be injected as a target fuel injection amount based on the engine operating state; a fuel injection pressure control section that controls a fuel injection pressure required for supplying fuel of the target fuel injection amount to the combustion chamber; a fuel injection timing control section that controls the timing at which fuel is injected to the combustion chamber; and a combustion state detection section that detects the deterioration of combustion of the internal combustion engine. The fuel injection timing control section includes a fuel pressure correction section that corrects the fuel injection pressure. The fuel pressure correction section corrects the fuel injection pressure when the deterioration of combustion of the internal combustion engine is detected by the combustion state detection section.

According to the present invention, when the shape of spray of the fuel injected from an injector is caused to extremely offset due to a variation of the injector, it is possible to prevent a lean misfire resulting from the adhesion of the fuel to a piston.

The above and other objects, features and advantages of the present invention will become more readily apparent to those skilled in the art from the following detailed description of a preferred embodiment of the present invention taken in conjunction with the accompanying drawings.

### BRIEF DESCRIPTION OF THE DRAWINGS

FIG. 1 is a block diagram showing a control apparatus for a direct injection type spark ignition internal combustion engine according to a first embodiment of the present invention.

FIG. 2 is a flow chart illustrating a correction procedure for fuel injection pressure at the time of combustion deterioration according to the first embodiment of the present invention.

FIG. 3 is an explanatory view schematically showing a set state of basic fuel injection pressure according to the first embodiment of the present invention.

FIG. 4 is a timing chart illustrating the operation of a combustion state detection section according to the first embodiment of the present invention.

FIG. 5 is an explanatory view schematically illustrating a combustion deterioration correction effect at the time of intake stroke injection according to the first embodiment of the present invention.

FIG. 6 is an explanatory view schematically illustrating a combustion deterioration correction effect at the time of compression stroke injection according to the first embodiment of the present invention.

### DESCRIPTION OF THE PREFERRED EMBODIMENT

Hereinafter, a preferred embodiment of the present invention will be described in detail while referring to the accompanying drawings.

### Embodiment 1

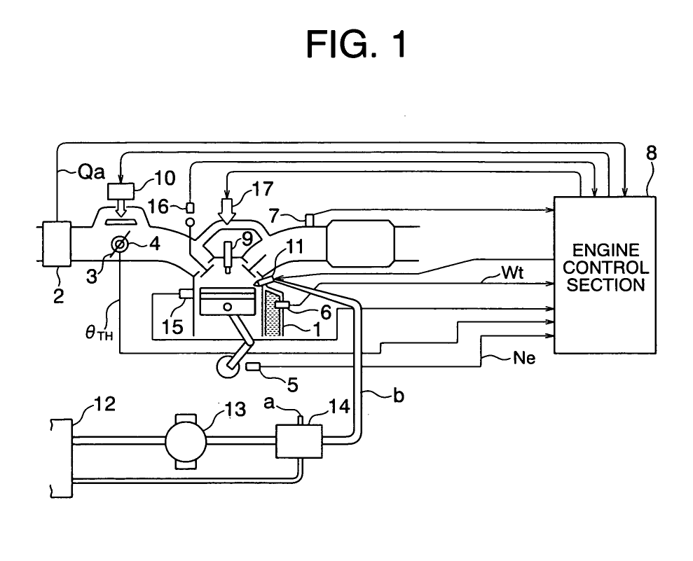

Referring to the accompanying drawings and first to FIG. 1, there is shown a control apparatus for a direct injection type spark ignition internal combustion engine according to a first embodiment of the present invention.

In FIG. 1, an internal combustion engine 1 (hereinafter referred to as an “engine”) has a cylinder or direct injection spark ignition type construction in which fuel is directly injected into a combustion chamber of a cylinder, and is installed on a vehicle such as for example a motor vehicle.

An air flow sensor 2, a throttle valve 3, and a throttle opening sensor 4 are arranged in an intake system of the engine 1. The air flow sensor 2 functions as an intake air amount sensor for measuring the amount of intake air Qa supplied to the engine 1 (or a parameter related to the amount of intake air). The throttle valve 3 is driven to rotate in association with an accelerator pedal (not shown), which is operated by a driver, so that the amount of intake air to the engine 1 is thereby adjusted.

The throttle opening sensor 4 serves to detect the position of the throttle valve 3 as a throttle opening θth.

On a bypass passage connected across or in parallel to the throttle valve 3, there is arranged a bypass valve 10 for opening and closing the bypass passage. The bypass valve 10 serves to adjust the amount of air flowing into the engine 1 while bypassing the throttle valve 3 so as to control the rotational speed Ne and the torque of the engine 1 at the time when the throttle valve 3 is fully closed (during idling operation).

Around the engine 1, there are arranged a crank angle sensor 5, a water temperature sensor 6, an oxygen sensor 7, a spark plug 9, an injector 11, a knock sensor 15, a cylinder identification sensor 16, and an EGR valve 17.

The crank angle sensor 5 is arranged in an opposed relation to a crankshaft of the engine 1 for detecting the rotational speed Ne and the crank angle position of the engine 1. The water temperature sensor 6 functions as a warm-up state detection section for detecting the warm-up state of the engine 1, and is arranged in the vicinity of cooling water for the engine 1 for detecting the temperature of the cooling water Wt (hereinafter referred to as a cooling water temperature). The oxygen sensor 7 is arranged in the exhaust system of the engine 1 for detecting the concentration of oxygen in the exhaust gas (air fuel ratio). The spark plug 9 is arranged in the combustion chamber of each cylinder of the engine 1 for firing an air fuel mixture therein. The injector 11 is arranged to protrude into the combustion chamber of each cylinder of the engine 1 for supplying high pressure fuel by injection to the combustion chamber. The knock sensor 15 is mounted on the outer periphery of the engine 1 for detecting knocking vibration of the engine 1. The cylinder identification sensor 16 is arranged in an opposed relation to a camshaft of the engine 1 for identifying a combustion cylinder. The EGR valve 17 serves to open and close an EGR passage for adjusting the flow rate of recirculation of the exhaust gas in EGR (exhaust gas recirculation that recirculates the exhaust gas to the intake system for reburning) control.

The detection signals of the various kinds of sensors 2, 4 through 7, 15 and 16 installed around the engine 1 (operating state information of the engine 1) are input to the engine control section 8 in the form of an electronic control unit (ECU).

The engine control section 8 determines the operating state of the engine 1 based on the information of the various kinds of sensors, and calculates control quantities of the various kinds of actuators 9 through 11 and 17 in accordance with the engine operating state thereby to perform various kinds of control. For example, the engine control section 8 performs air fuel ratio feedback control based on the injector 11 so as to burn the air fuel mixture in the engine 1 at a desired the air fuel ratio, ignition timing control (including knocking avoidance control etc.) based on the spark plug 9 so as to operate the engine 1 with maximum efficiency, EGR control based on the EGR valve 17 so as to suppress the generation of NOx by recirculating the exhaust gas to the intake system for reburning thereof, fuel injection timing control based on the injector 11 so as to change the injection timing of fuel in accordance with the operating state of the engine 1, and control of the rotational speed Ne at the time of idling operation based on the bypass valve 10 and torque control during travel.

In addition, the engine control section 8 includes a combustion deterioration suppression section for suppressing the deterioration of combustion of the engine 1. Thus, the engine control section 8 includes the various kinds of sensors 2, 4 through 7, 15 and 16 that detect the operating state of the engine 1, a target fuel injection amount calculation section that calculates a target value for the amount of fuel to be injected as a target fuel injection amount based on the engine operating state, a fuel injection pressure control section that controls fuel injection pressure Pi required for supplying fuel of the target fuel injection amount to each combustion chamber, and a fuel injection timing control section that controls the timing at which fuel is injected to each combustion chamber, a combustion state detection section that detects the deterioration of combustion of the engine 1. The fuel injection timing control section includes a fuel pressure correction section that corrects the fuel injection pressure Pi.

For example, the combustion state detection section in the engine control section 8 detects the deterioration of combustion of the engine 1 based on an amount of change of the rotational speed Ne of the crankshaft. The fuel pressure correction section in the engine control section 8 functions as a combustion deterioration suppression section, and corrects the fuel injection pressure Pi when the deterioration of combustion of the engine 1 is detected by the combustion state detection section.

Specifically, when the deterioration of combustion of the engine 1 is detected, the fuel pressure correction section corrects the fuel injection pressure Pi in a pressure decreasing direction. A fuel tank 12 is connected to the injector 11 through a fuel pump 13 and a high-pressure pump 14 including a fuel pressure regulator. The fuel pump 13 takes out fuel from the fuel tank 12, and the fuel pressure regulator controls the fuel pressure to be supplied to the high-pressure pump 14. That is, the fuel pressure regulator adjust the fuel pressure based on the atmospheric pressure detected at point a in such a manner that the fuel pressure at point b becomes a predetermined constant pressure, and the high-pressure pump 14 controls the injection pressure of the fuel supplied to the injector 11. As a result, the fuel pressure supplied to the injector 11 is adjusted so as to coincide with a control value based on the atmospheric pressure detected at point a. In the direct injection type spark ignition internal combustion engine, it is necessary to impress a fuel pressure higher than or equal to the cylinder internal pressure of the engine 1 to the injector 11. Accordingly, the predetermined constant pressure is set to a pressure of several tens atmospheres for example, based on the atmospheric pressure.

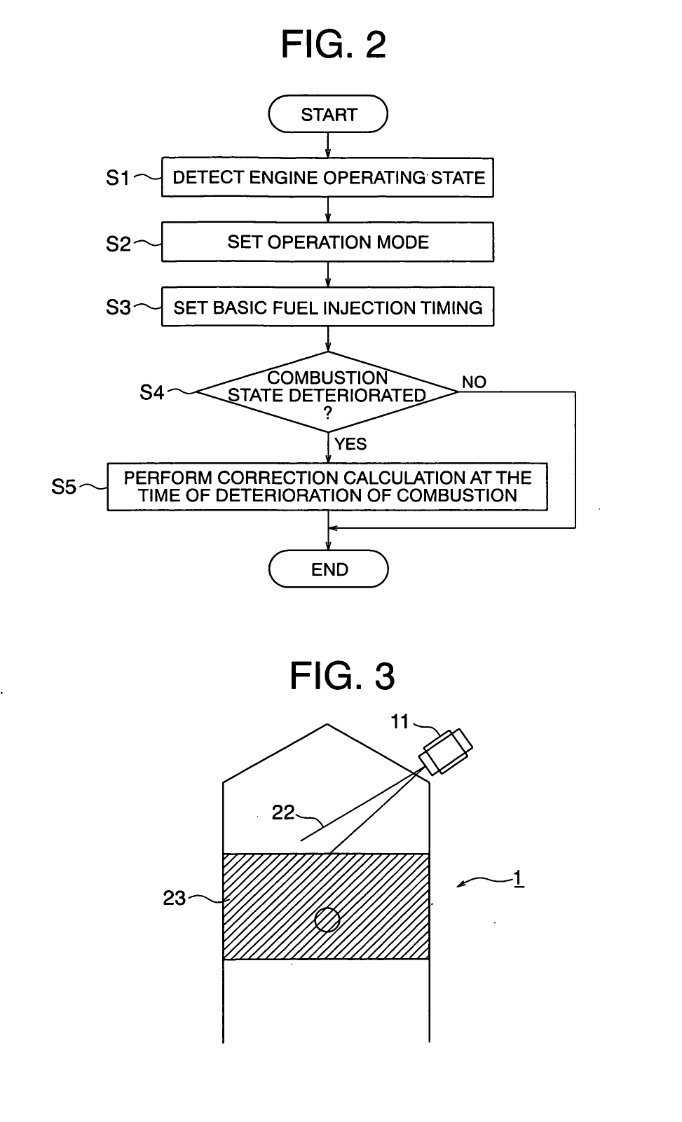

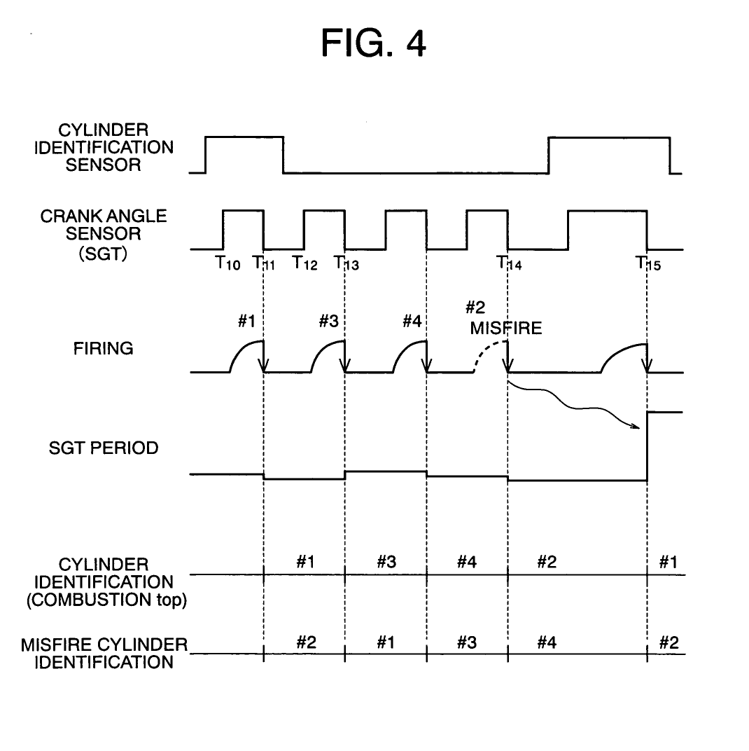

Next, reference will be made to a procedure for correcting the fuel injection pressure Pi according to the engine control section 8 upon detection of the deterioration of combustion while referring to an explanatory view of FIG. 3 and a timing chart of FIG. 4 together with a flow chart of FIG. 2. Here, note that step S3 in FIG. 2 corresponds to the fuel injection timing control section, step S4 corresponds to the combustion state detection section, and step S5 corresponds to the fuel pressure correction section.

In FIG. 2, first of all, the operating state of the engine 1 is detected (step S1). At this time, the processing of detecting the engine operating state is executed by determining or identifying a specific cylinder with respect to the rotation of the crankshaft, based on the pulse periods of the detection signals from the crank angle sensor 5 and the cylinder identification sensor 16 corresponding to the respective cylinders, and detecting the engine rotational speed Ne. Also, the engine operating state detection procedure is executed by detecting the degree of opening θTH or the fully closed state of the throttle valve 3, and detecting the amount of intake air Qa.

Subsequently, the loaded state of the engine 1 is determined based on the detection result of the engine operating state, and the operation mode of the engine 1 (a fuel injection mode such as an intake stroke injection mode, a compression stroke injection mode, etc.) is selectively set (step S2).

In addition, when the injection mode is set, basic fuel injection timing is set and a basic fuel injection pressure, which becomes a reference value, is set (step S3).

FIG. 3 is an explanatory view that schematically shows a set state of the basic fuel injection pressure in step S3, wherein the basic fuel injection pressure is set to such a fuel injection pressure Pi at which the fuel sprayed or injected, as designated at 22, does not adhere to the piston 23.

If the injector 11 is driven based on the fuel injection pressure Pi thus decided, fuel can be injected at a pressure in the range in which the fuel sprayed 22 does not adhere to the piston 23, whereby it is possible to prevent the deterioration of combustion generated from fuel adhesion.

When the fuel injection pressure Pi, which becomes the reference value, is set, the combustion state detection section in the engine control section 8 then determines whether the combustion state of the engine 1 has been deteriorated (step S4). In this regard, FIG. 4 illustrates, in a timing chart, the operation of the fuel state detection section.

In FIG. 4, the cylinder identification sensor 16 detects the first one (#1) of four cylinders (#1 through #4) as a specific cylinder, and generates a rectangular pulse corresponding to the first cylinder alone as a cylinder identification signal. Also, the rising timing of the crank angle signal from the crank angle sensor 5 indicates an angle of 75 degrees (crank angle) before the top dead center (compression top dead center) of each cylinder, and at the same time, the falling timing of the crank angle signal indicates the top dead center of each cylinder.

Accordingly, the individual cylinders and the states of the individual cylinders can be determined by the cylinder identification signal and the crank angle signal from the cylinder identification sensor 16. For example, at time point T10 in FIG. 4, the cylinder identification signal is at an H level, so it is found that the specific cylinder is the first cylinder (#1), and since the crank angle signal rises there, it is also found that the crank angle position of the first cylinder is 75 degrees before top dead center (TDC). Similarly, it is found that at time point T11, the first cylinder is at top dead center.

Although the cylinder identification sensor 16 outputs no signal for the cylinders (#2 through #4) other than the first cylinder, the engine control section 8 can identify, based on the prescribed order of the respective cylinders (#1→#3→#4→#2), in which state each cylinder is. That is, the control sequence of the respective cylinders of the engine 1 is determined in advance, and for example, in case of four cylinders, such a sequence is as follows: the first cylinder→the third cylinder→the fourth cylinder→the second cylinder→the first cylinder.

Accordingly, it is known that when the cylinder identification sensor 16 identifies the first cylinder, the following cylinder will be the third cylinder, and it is found that at time point T12, the crank angle is 75 degrees before TDC of the third cylinder. Also, the remaining cylinders can be identified according to a similar method.

In addition, the rotational fluctuation of the engine 1, which becomes a condition for determination of the deterioration of combustion in step S4, can be detected by measuring the period of the crank angle signal (the time that it takes for the crankshaft to rotate a predetermined angle).

Hereinafter, reference will be made to the case in which the period of the falling timing of the crank angle signal, as shown in FIG. 4, is measured as the signal period of the crank angle sensor 5.

In this case, since the output of the engine 1 generated by ignition or firing of the mixture at time point T11 first drives the crankshaft to rotate at a speed corresponding to the magnitude of the output thus generated, so the larger the generated output, the earlier the following falling timing will be detected.

Accordingly, the period of time from the time point T11 to time point T13 is measured, and the shorter this measurement period, it can be determined that combustion in the first cylinder is well carried out. On the contrary, it can be determined that the longer the measuring period, combustion in the first cylinder is deteriorated.

Hereinafter, the combustion state of the ignition controlled cylinder can be detected in the same way in the order of the third cylinder, the fourth cylinder and the second cylinder. Here, note that the processing of determining the deterioration of combustion is not limited to the above-mentioned method, but a method of measuring an ionic current or a change in acceleration, etc., can be considered.

Thereafter, when it is determined in step S4 that the combustion state of the engine 1 is normal (that is, NO), the processing routine of FIG. 2 is terminated without executing the correction processing, whereas when it is determined in step S4 that the combustion state is deteriorated (that is, YES), the fuel pressure correction section in the engine control section 8 executes the correction calculation of the fuel injection pressure Pi at the time of the deterioration of combustion (step S5), and the processing routine of FIG. 2 is terminated.

The correction calculation at the time of the deterioration of combustion in step S5 is executed by using a basic correction amount Pk of the fuel injection pressure Pi, a correction factor K1 set in accordance with a variation range of the rotational speed Ne, and a correction factor K2 set in accordance with a cooling water temperature Wt, as shown by the following expression (1).

P(i)=Pi+Pk×K1×K2 (1)

In expression (1) above, the correction amount Pk of the fuel injection pressure Pi is always a negative value, so a fuel injection pressure P(i) after the correction is corrected without fail in a decreasing direction.

Hereinafter, by controlling the high-pressure pump 14 so as to make its injection pressure coincide with the fuel injection pressure P(i) decided by expression (1) above, the fuel injected from the injector 11 can be prevented from adhering to the piston 23, and the deterioration of fuel mileage can be suppressed.

Here, note that the correction calculation at the time of the deterioration of combustion is not limited to the above-mentioned expression (1), but the corrected fuel injection pressure P(i) may instead be corrected, for example, by using a current reference value Pi and the last corrected value P(i−1), as shown by the following expression (2).

P(i)=Pi+P(i−1)×K1×K2 (2)

Thus, when the deterioration of the combustion state is detected, fuel adhesion can be prevented by correcting the fuel injection pressure P(i).

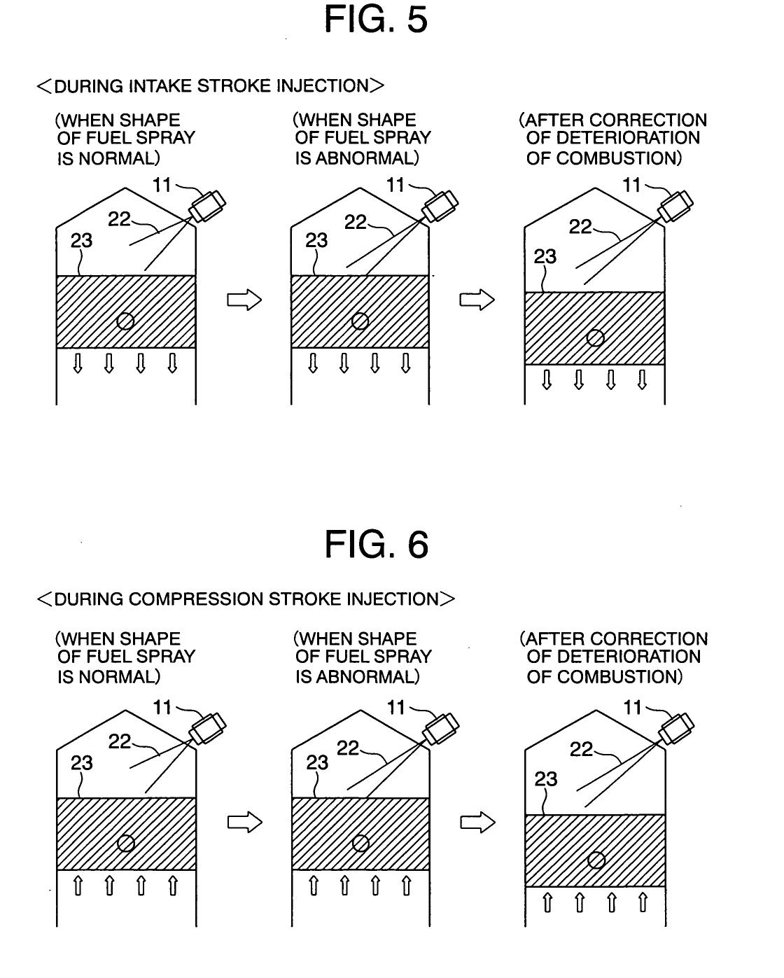

Next, reference will be made to the effect of correction at the time of the deterioration of combustion according to the first embodiment of the present invention while referring to FIGS. 5 and 6.

FIGS. 5 and 6 are explanatory views that schematically show the correction effect at the time of the deterioration of combustion, wherein FIG. 5 shows a combustion deterioration correction effect during intake stroke injection, and FIG. 6 shows a combustion deterioration correction effect during compression stroke injection.

In FIGS. 5 and 6, in case where the shape of the fuel spray 22 is changed from “a normal shape” to “a fuel spray abnormal shape” due to the deterioration of performance of the injector 11 to generate a state that the fuel spray 22 adheres to the piston 23, such a situation can be a factor to cause the deterioration of combustion.

However, like “after the correction at the time of the deterioration of combustion”, as shown in the final stage of FIGS. 5 and 6, by executing the correction processing at the time of the deterioration of combustion so as to inject fuel within the range where the fuel spray 22 does not adhere to the piston 23, it is possible to prevent the adhesion of fuel to the piston 23.

Although in the foregoing description, the first embodiment of the present invention has been specifically described, the present invention is not limited to the above-mentioned explanation. For example, in the above-mentioned first embodiment, reference has been made to the case where the present invention is applied to an inline four-cylinder direct injection engine, but the present invention is applicable to various kinds of engines, which are different in the number of cylinders and the arrangement thereof, such as single-cylinder engines, V-type six-cylinder engines. Thus, the present invention may be applied to engines that use fuel (methanol, etc.) other than gasoline, and may also be applied to direct injection gasoline engines that are not provided with a late injection mode.

Further, the concrete configuration, construction and the like of the control system can be changed within the range in which it does not depart from the spirit of the present invention.

As described above, the control apparatus for a direct injection type spark ignition internal combustion engine according to the first embodiment of the present invention, when the shape of spray of the fuel injected from the injector 11 is caused to extremely offset due to an individual variation of the injector 11, it is possible to prevent a lean misfire resulting from the adhesion of the fuel to the piston 23.

In addition, since the fuel pressure correction section (step S5) in the engine control section 8 suppresses the deterioration of combustion by correcting the fuel pressure in a pressure decreasing direction, there occurs no adverse influence on the exhaust emission such as an increase of HC due to the enrichment of fuel.

Moreover, since the combustion state detection section (step S4) detects the deterioration of combustion of the engine 1 based on the amount of change of the rotational speed Ne of the crankshaft by using the regularly provided crank angle sensor 5, there is no particular need to add an additional sensor, and hence there will be no increase in cost.

While the invention has been described in terms of a preferred embodiment, those skilled in the art will recognize that the invention can be practiced with modifications within the spirit and scope of the appended claims.

What is claimed is:

1. A fuel control apparatus for a direct injection type spark ignition internal combustion engine in which fuel is directly injected to a combustion chamber of the internal combustion engine, said apparatus comprising:
a variety of kinds of sensors that detect an operating condition of said internal combustion engine;
a target fuel injection amount calculation section that calculates a target value for an amount of fuel to be injected as a target fuel injection amount based on said engine operating state;
a fuel injection pressure control section that controls a fuel injection pressure required for supplying fuel of said target fuel injection amount to said combustion chamber;
a fuel injection timing control section that controls the timing at which fuel is injected to said combustion chamber; and
a combustion state detection section that detects the deterioration of combustion of said internal combustion engine;
wherein said fuel injection timing control section includes a fuel pressure correction section that corrects said fuel injection pressure; and
said fuel pressure correction section corrects said fuel injection pressure when the deterioration of combustion of said internal combustion engine is detected by said combustion state detection section.

2. The fuel control apparatus for a direct injection type spark ignition internal combustion engine as set forth in claim 1, wherein
when the deterioration of combustion of said internal combustion engine is detected, said fuel pressure correction section corrects said fuel injection pressure in a pressure decreasing direction.

3. The control apparatus for a direct injection type spark ignition internal combustion engine as set forth in claim 1, further comprising:
a crank angle sensor that detects the rotational speed of a crankshaft of said internal combustion engine;
wherein said combustion state detection section detects the deterioration of combustion of said internal combustion engine based on an amount of change of the rotational speed of said crankshaft.
